(19) United States
(12) Patent Application Publication
(10) Pub. No.: US 2011/0145152 A1
(43) Pub. Date: Jun. 16, 2011

(54) SYSTEMS, APPARATUS, AND METHODS FOR IDENTITY VERIFICATION AND FUNDS TRANSFER VIA A PAYMENT PROXY SYSTEM

(76) Inventor: Steven Harvey McCown, Rigby, ID (US)

(21) Appl. No.: 12/968,237

(22) Filed: Dec. 14, 2010

Related U.S. Application Data
(60) Provisional application No. 61/286,745, filed on Dec. 15, 2009.

(51) Int. Cl. G06Q 20/00; G06Q 40/00

(52) U.S. Cl. 705/67; 705/44

(57) ABSTRACT

Systems, apparatus, and methods for verifying a user's identity and conducting a transfer of funds via a payment proxy system are herein provided. A message including a request for verification of the user's identity and/or a transfer of funds via a proxy payment system may be received. The message may also include user identification information and/or a token. Completion of the identification verification and/or requested funds transfer may be dependent upon verification of user identification information and/or a token.

### RELATED APPLICATION

This application is a NONPROVISIONAL of, claims priority to, and incorporates by reference U.S. Provisional Patent Application 61/286,745 filed 15 Dec. 2009.

### FIELD OF INVENTION

The present invention relates to systems, methods, apparatus, and computer-readable media for verifying a user's identity and conducting a transfer of funds via a payment proxy system.

### BACKGROUND

For many years, credit card terminals have allowed users to pay for goods and services at cash register point-of-sale systems, worldwide. Conventionally, the buyer obtains an account with a financial institution that either runs its own “closed loop” credit card system (e.g., Diners Club and American Express) or subscribes to an “open loop” credit card system allowing for cooperation of financial institutions implementing a standardized system (e.g., Visa and Mastercard). In either implementation, the buyer is able to use the credit card in lieu of cash to immediately obtain goods or services, and then pay the credit card bill at a later date. This method of payment benefits that buyer to the extent that it reduces the buyers need to carry cash. It also benefits the seller as it facilitates impulse purchases or other transactions for which the buyer does not currently have funds.

With the advent of the Internet, yesterday's product catalogs have become today's commercial websites. Such websites allow buyers to type their credit card number into online shopping forms and received the purchased item via mail delivery services. While convenient, such online shopping methods may afford hackers or other ill intentioned entities, the opportunities to illicitly capture a buyer's credit card number or other personally identifying information and use it for illegal purposes. In partial mitigation of this risk, online payment companies or payment proxy companies (e.g. PayPal™, Google Checkout™) have emerged that serve as a go-between in the purchase process while hiding the credit card number from the seller and any potential eavesdroppers. This allows buyers to purchase online without disclosing their credit card numbers.

Customer loyalty cards are very popular among merchants trying to incentivize customers into returning for subsequent visits and making repeat purchases. Quite frequently, customer loyalty cards are handed out at a cash register during check out at a retail sale establishment. During that process, the customer is typically handed a card with a unique number on it as well as a paper application enabling enrollment in the loyalty program that the customer must fill out and either leave with or mail to the merchant. Some merchants allow a credit card to be assigned to the loyalty card while others combine multiple loyalty cards into a single card such as Capital One's Mileage Plus Card.

### BRIEF DESCRIPTION OF THE FIGURES

The present application is illustrated by way of example, and not limitation, in the figures of the accompanying drawings in which:

FIG. 1A is a block diagram illustrating an exemplary system in accordance with an embodiment of the present invention;

FIG. 1B is a block diagram illustrating an exemplary system in accordance with an embodiment of the present invention;

FIG. 1C is a block diagram illustrating an exemplary system in accordance with an embodiment of the present invention;

FIG. 2 is a block diagram illustrating an exemplary communication device in accordance with an embodiment of the present invention;

FIG. 3 is a block diagram illustrating an exemplary token in accordance with an embodiment of the present invention;

FIG. 4 is a flowchart illustrating an exemplary process for verifying a user's identity in accordance with an embodiment of the present invention;

FIG. 5 is a flowchart illustrating an exemplary process for transferring funds in accordance with an embodiment of the present invention;

FIG. 6 is a flowchart illustrating an exemplary process for transferring funds in accordance with an embodiment of the present invention; and

FIG. 7 is a flowchart illustrating an exemplary process for conducting a financial transaction in accordance with an embodiment of the present invention.

### SUMMARY

Systems, apparatus, and methods for verifying a user's identity and conducting a transfer of funds via a payment proxy system are herein provided. In one embodiment, a first message may be received from a transaction device at, for example, a server. The transaction device may be associated with, for example, a merchant, an organization, a security verification entity, a members-only club, a retail establishment, and/or a government entity.

The first message may include a request from a communication device operated by a user for an identification verification of the user and a token. The token may include a globally unique identifier (GUID) unique to the communication device, and/or user identification information associated with the user requesting the verification. The server may receive the message via, for example, a wireless communication link and/or a physical connection between the communication device and the transaction device.

The token may be analyzed according to, for example, one or more criterion by, for example, the server. In one embodiment, the server is in communication with a database and the analysis of the token and/or the user identification information may be based on communication between the server and the database.

An identification of the user may then be verified in response to the analysis. A second message may then be transmitted to, for example, the transaction device indicating whether the identification is verified.

In one embodiment, additional information may be received from the user. On some occasions, the additional information is received in response to a prompt for the information. Exemplary additional information includes a personal identification number (PIN) and information specific to an account the user has with and entity associated with the token. The received additional information may be analyzed according to, for example, one or more criterion and the accuracy of the received additional information may be verified

In another embodiment, the server may receive a message from a transaction device. The message may include a request for funds from a proxy payment system communicatively coupled to the server and/or user identification information associated with a user requesting the funds. The message may be received by the server via, for example, a wireless communication link and/or a physical connection between a communication device operated by the user and the transaction device. In some embodiments, the message may be received by the transaction device from a communication device operated by the user and the user identification information may include a globally unique identifier (GUID) specific to the communication device and information specific to an account the user has with, for example, the payment proxy service and/or the financial institution.

The accuracy of the user identification information may be verified according to, for example, one or more criterion. The message may then be transmitted to the proxy payment system responsively to the verification and the requested funds may be received from, for example, the proxy payment system. The requested funds may then be transferred from the server to the transaction device. On some occasions, the proxy payment system may be in communication with a financial institution and the requested funds may be transferred to the proxy payment system from the financial institution prior to the transfer of the requested funds from the proxy payment system to the transaction device.

In some cases, additional information may be received from the user at, for example, the server and may be received in response to a prompt for the information. Exemplary additional information includes a PIN, information specific to an account the user has with the proxy payment system, information specific to an account the user has with a financial institution in communication with the proxy payment system, and a GUID specific to a communication device operated by the user requesting the funds via which the message is communicated to the transaction device.

The accuracy of the received additional information may be verified by, for example, the server and/or the proxy payment system. Receipt of the requested funds and/or the transfer of requested funds may be responsive to verification of the additional information.

In one embodiment, a message may be transmitted to, for example, the transaction device and the communication device indicating a transfer of funds from the proxy payment system to the transaction device.

In another embodiment, wherein the user has an account with a financial institution and the proxy payment system, the user identification information may include a token linked to the account with the proxy payment system and the proxy payment system may be enabled to access the account with the financial institution via the token.

In yet another embodiment, a message may be received from a communication device by a transaction device. The message may include a request for funds from a financial institution and/or user identification information associated with a communication device. The message may be received by the transaction device via, for example, a wireless communication link and/or a physical connection between the communication device and the transaction device. In some embodiments, the message may be received by the transaction device from a communication device operated by the user and the user identification information may include a globally unique identifier (GUID) specific to the communication device and information specific to an account the user has with, for example, the payment proxy service and the financial institution.

The message may then be transmitted to a server in communication with the proxy payment system and the proxy payment system may be in communication with the financial institution. The accuracy of the user identification information may then be verified according to, for example, one or more criteria. On some occasions, the user identification information may include a token linked to an account with the proxy payment system, and the proxy payment system may be enabled to access an account with the financial institution via the token.

The message may then be transmitted to the proxy payment system responsively to the verification and the requested funds may be received from, for example, the proxy payment system. Authorization from the proxy payment system may then be received by the server thus enabling a transfer requested funds from the proxy payment system and/or the financial institution, via a transfer by the proxy payment system, to the transaction device. The requested funds may then be transferred from the server to the transaction device. On some occasions, the proxy payment system may be in communication with a financial institution and the requested funds may be transferred to the proxy payment system from the financial institution prior to the transfer of the requested funds from the proxy payment system to the transaction device.

In one embodiment, a user may be prompted by, for example, the transaction device, for additional information. Exemplary additional information includes a PIN, information specific to an account the user has with the proxy payment system, and information specific to an account the user has with the financial institution. The additional information may then be received from the user. The accuracy of the received additional information may be verified by, for example, the transaction device, the server, and/or the proxy payment system. In some cases, the authorization and/or the transfer of the requested funds may be responsive to verification of the additional information.

In one embodiment, a message may be transmitted to the communication device indicating a transfer of funds from, for example, the proxy payment system and/or the financial institution to the transaction device.

In another embodiment, notification of an identification device activation and user identification information may be received by, for example, a server. Exemplary identification devices include a token, a radio frequency identification (RFID) tag, a magnetic identification device, and a software application running on a communication device, such as a mobile phone. In some embodiments, the notification and the user identification information is received via a secure encrypted transmission.

It may then be determined whether a recognized account is associated with the identification device and/or received user identification information. The user may then be prompted for additional information regarding an account the user has with a financial institution responsively to a determination that no recognized account is associated with the identification device and received user identification information. The received user identification information may include, for example, information regarding a personally identifying communication mechanism and the prompting may include transmitting, by the server, a request for information regarding an account the user has with a financial institution via the personally identifying communication mechanism. Exemplary personally identifying communication mechanisms include telephones, mobile telephones, communication devices, laptop computers, and personal computers. Exemplary prompts include an email, a text message, and a phone call.

The additional information may be received, in response to the prompt, from the user and a user account may be generated with the received information. Next, a financial transaction may be conducted via the user account.

Exemplary tokens described herein include GUID information associated with a communication device operated by a user, user identification information associated with the user and/or user account information associated with the user.

Exemplary systems described herein may include a communication device, a token, and a transaction device. The communication device may include, for example, a user interface for receiving instructions from a user and a request for at least one of a user identification verification and funds from a proxy payment system, a processor for processing the received instructions, the request, and a token, and a transceiver for transmitting the request and the token and receiving at least one of a user identification verification and/or requested funds. The token may be communicatively coupled to the communication device and may include GUID information associated with the communication device, user identification information associated with a user, and user account information associated with the user and an entity maintaining the token. The transaction device may be communicatively coupled to the communication device and/or token and may be operable to read the token. In some embodiments, the system may further include a server communicatively coupled to the transaction device and operable to communicate with an identification verification system and a proxy payment system.

### WRITTEN DESCRIPTION

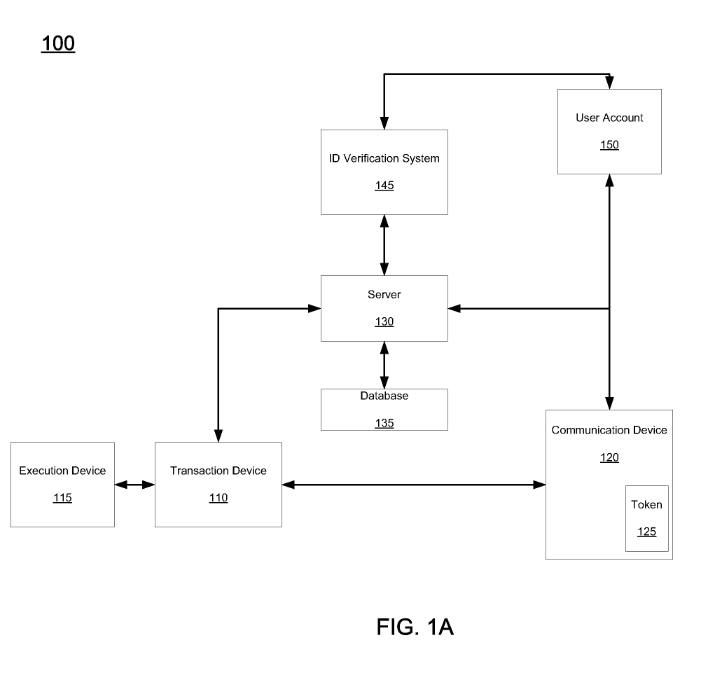

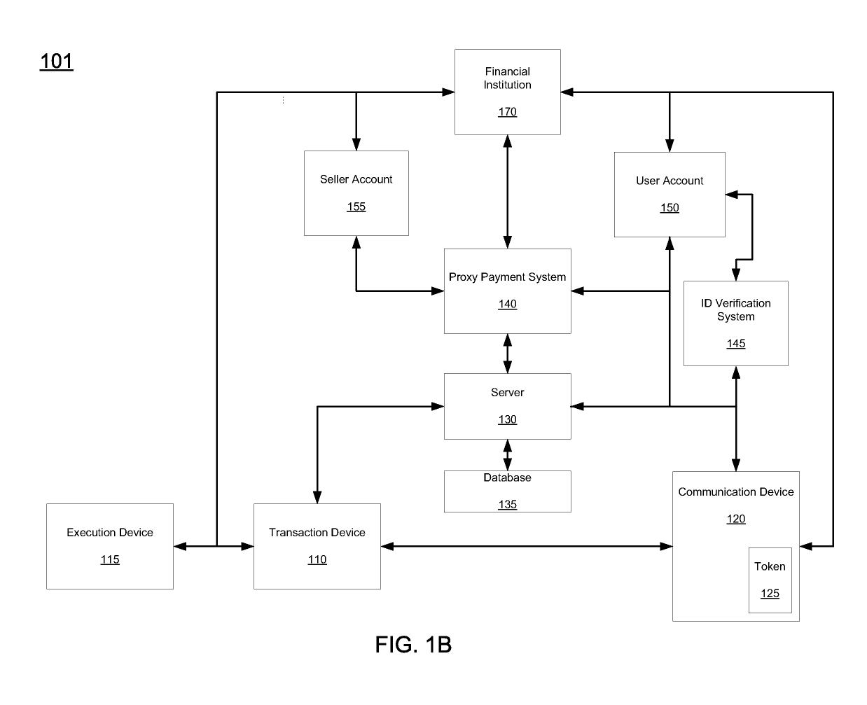

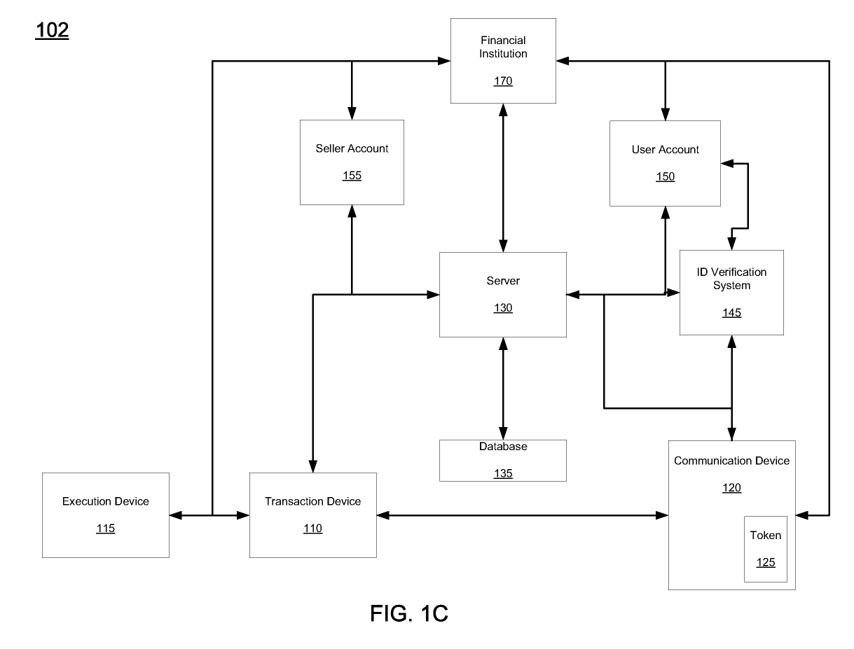

FIG. 1A is a block diagram illustrating an exemplary system 100 within which any one or more of the methodologies discussed herein may be executed. System 100 includes a transaction device 110, an execution device 115, a communication device 120, a token 125, a database 135, a server 130, an identification verification system 145, a user account 150, and multiple communication links operating to communicatively couple two or more components of system 100 with one another. The communication links may be wired or wireless.

Transaction device 110 may be any device capable of communicating with communication device 120 and server 130. On some occasions, transaction device 110 may be enabled to read token 125. Transaction device 110 may be associated with, for example, a merchant, an organization, a security verification entity, a government entity, a members-only club, and/or a retail establishment. Exemplary transaction devices 110 include a token reader, a point of sale transaction device operated by a merchant, a credit card reader, a key fob reader, a magnetic card reader, and a computing device such as a laptop computer or a cash register.

Transaction device 110 may be enabled to transmit a request to server 130. Transaction device 110 may also be enabled to directly, or indirectly, execute a requested transaction, such as completing a retail sale transaction or allowing entry into a secure location. In some embodiments, transaction device 110 may further be coupled to one or more devices execution devices 115.

Execution device 115 may be enabled to execute an action upon receiving notification from transaction device 110 that an identity has been verified and/or the act is permissible. For example, when execution device 115 is a security gate that requires an identity verification prior to opening and an identity verification has been received by transaction device 110, transaction device 110 may transmit a message to the security gate indicating that the identity verification has been received and therefore the security gate may be enabled to open.

In another example, execution device 115 may be a cash register and transaction device 110 may be a point of sale transaction device. Transaction device 110 may receive a request from a user to purchase an alcoholic beverage and proof of the user's identity and/or age may be required to complete the sale of the alcoholic beverage. In this case, transaction device 110 may transmit a message to, for example, server 130 and/or identification verification system 145 requesting verification of the user's identity (which could include the user's age). Server 130, identification verification system 145, and/or database 135 may then act together, or separately, in order to verify the user's identity and transmit such verification to transaction device 110. Upon receiving the verification, transaction device 110 may direct the cash register (execution device 115) to complete the sale of the alcoholic beverage to the user.

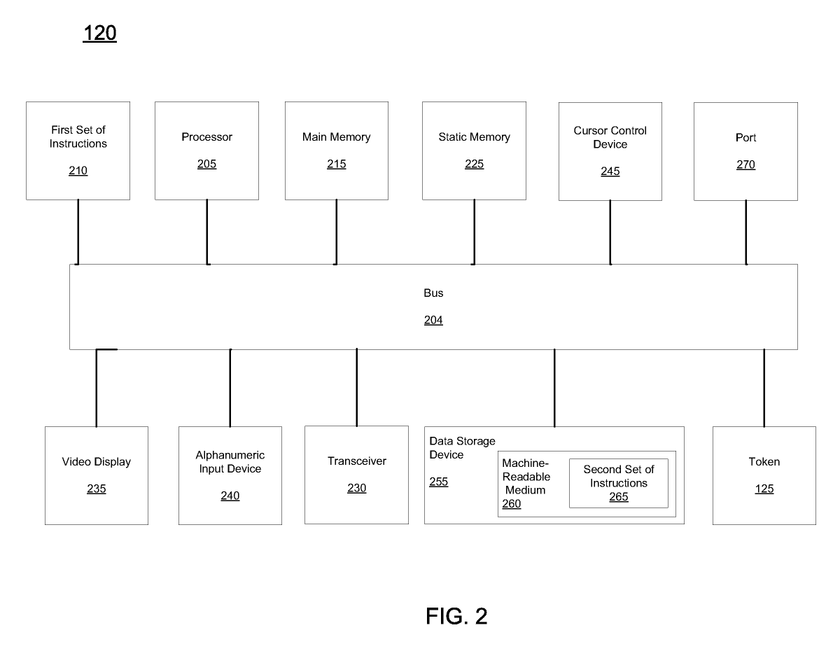

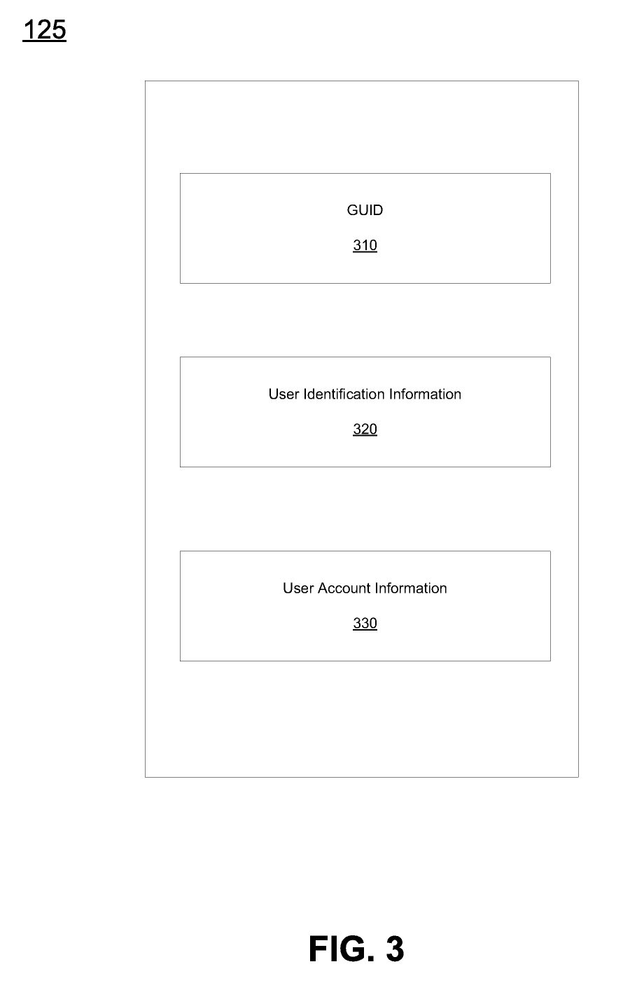

Communication device 120 may be communicatively coupled with transaction device 110, server 130, and user account 150 and may include token 125. Further details regarding the components included in communication device 120 and token 125 are discussed below with regard to FIGS. 2 and 3, respectively. The communicative coupling between communication device 120 and transaction device 110 may be via, for example, a wireless communication link, a wired communication link, and/or a physical connection between communication device 120 and transaction device 110 (e.g., touching or “bumping”). Communication device 120 may be operated by a user and may be operable to set up and/or manage user accounts 150 with, for example, server 130 and/or identification verification system 145.

Communication device 120 may further be operable to transmit a request for an identification verification to transaction device 110. In some embodiments, the request may include a request for an identification verification of a user associated with server 130, identification verification system 145, and/or user account 150 and a token. Communication device 120 may also be enabled to receive a message from, for example, transaction device 110, server 130, user account 150, and/or identification verification system 145.

Server 130 may be communicatively coupled to, for example, transaction device 110, communication device 120, database 135, and identification verification system 145. Server 130 may be enabled to receive and process a request and/or additional information from transaction device 110 and/or communication device 120.

For example, server 130 may be enabled to analyze a received request and/or received additional information according to one or more criteria. In some embodiments, this analysis may include accessing information stored in database 135. The server may also be enabled to verify the identification of the user based upon the analysis and transmit a message to, for example, transaction device 110 and/or communication device 120 indicating whether the user's identity has been verified.

Identification verification system 145 may be communicatively coupled with, for example, execution device 115, server 130, and/or user account 150. Identification verification system 145 may be any system capable of verifying a user's identity. On some occasions, a user may have a user account 150 with, for example, identification verification system 145, and execution of the identity verification by identity verification system 145 may be performed in conjunction with user account 150. Exemplary entities that may operate identification verification system 145 include financial institutions, governmental entities, the Transportation Security Administration (TSA), members-only clubs, retail establishments, pharmacies, employers, and security personnel or equipment.

FIG. 1B is a block diagram illustrating an exemplary system 101 within which any one or more of the methodologies discussed herein may be executed. System 101 includes transaction device 110, execution device 115, communication device 120, token 125, database 135, server 130, identification verification system 145, user account 150, a proxy payment system 140, a seller account 155, a financial institution 170, and multiple communication links operating to communicatively couple two or more components of system 100 with one another. The communication links may be wired or wireless.

Proxy payment system 140 may be any system via which a proxy payment or funds transfer may be transacted. Exemplary proxy payment systems 140 include PayPal™, Google Checkout™, Amazon™ payments, and Facebook™ payments. A user may enroll in and/or maintain one or more user accounts 150 with server 130, proxy payment system 140 and/or financial institution 170 and may make payments and/or transfer funds to, for example, transaction device 110 and/or execution device 115 via server 130, proxy payment system 140, financial institution 170, and/or user account 150. Likewise, a seller, or merchant, may enroll in and/or maintain one or more seller accounts 155 with server 130, proxy payment system 140, and/or financial institution 170 and may receive payments and/or transferred funds via, for example, transaction device 110 and/or execution device 115 from server 130, proxy payment system 140, financial institution 170, and/or user account 150. Data entered by the user and/or seller during an enrollment or maintenance process may be stored in database 135.

Upon receiving a request for funds, proxy payment system 140 may, for example, verify the identity of a user requesting the funds, verify the validity of the request, verify the identity of transaction device 110, access an account associated with the user requesting the funds, request funds from financial institution 170, verify that there are funds in the account sufficient to meet the amount of requested funds, receive the requested funds from financial institution 170, and the and/or transfer the requested funds to transaction device 110, seller account 155, and/or execution device 115.

Financial institution 170 may be any institution or entity enabled to conduct financial transactions with, for example, user account 150, seller account 155, communication device 120, execution device 115, transaction device 110, and/or proxy payment system 140. Exemplary financial institutions 170 include banks, credit card companies, and credit unions.

Server 130 may be enabled to receive a message from, for example, transaction device 110 including a request for funds from proxy payment system 140 and user identification information associated with a user requesting the funds. The request may be initially received by transaction device 110 from communication device 120. Server 130 may also be enabled to verify the accuracy of received user identification information independently and/or via communication with identification verification system 145, proxy payment system 140, and/or user account 150.

Server 130 may also be enabled to transmit a message to, for example, proxy payment system 140 indicating the request and/or verification of user's identity. Server 130 may then receive, directly or indirectly, the requested funds from, for example, proxy payment system 140, user account 150, and/or financial institution 170 and may transfer the received funds to, for example, transaction device 110, seller account 155, financial institution 170, and/or execution device 115.

In one embodiment server 130 may also transmit a message to transaction device 110, communication device 120, and/or execution device 115 indicating a transfer of funds and/or completion of a transaction.

FIG. 1C is a block diagram illustrating an exemplary system 102 within which any one or more of the methodologies discussed herein may be executed. System 102 includes transaction device 110, execution device 115, communication device 120, token 125, database 135, server 130, identification verification system 145, user account 150, seller account 155, financial institution 170, and multiple communication links operating to communicatively couple two or more components of system 100 with one another. The communication links may be wired or wireless.

System 102 is similar to system 101, with the exception that, in system 102, server 130 is directly connected to financial institution 170 without an intervening proxy system 140. This arrangement allows for server 130 to communicate directly with the financial institution 170.

FIG. 2 is a block diagram illustrating an exemplary communication device 120 within which a first set of instructions 210 may be executed, for causing communication device 120 to perform any one or more of the methodologies discussed herein. In alternative embodiments, communication device 120 operates as a standalone device or may be connected (e.g., network or communication link) to other machines and/or communication devices. communication device 120 may be, for example, a mobile communication device, a mobile phone, a smart phone, a key fob, a Radio-frequency identification (RFID) enabled device, a magnetic key card, a tablet computer, a laptop computer, a personal digital assistant (PDA), a cellular telephone, or any communication device capable of executing a set of instructions (sequential or otherwise) that specify actions to be taken by that communication device. Further, while only a single communication device 120 is illustrated, the term (communication device) shall also be taken to include any collection of machines that individually or jointly execute a set (or multiple sets) of instructions to perform any one or more of the methodologies discussed herein.

Exemplary communication device 120 includes a processor 205 (e.g., a central processing unit (CPU), a graphics processing unit (GPU), or both), a main memory 215 (e.g., read-only memory (ROM), flash memory, dynamic random access memory (DRAM) such as synchronous DRAM (SDRAM) or Rambus DRAM (RDRAM), etc.), and a static memory 225 (e.g., flash memory, static random access memory (SRAM), etc.), which communicate with each other via a bus 204.

Communication device 120 may further include a video display 235 (e.g., a liquid crystal display (LCD), an LCD capacitive touchscreen, or a light emitting diode (LED) display). Communication device 120 also includes an alphanumeric input device 240 (e.g., a keyboard or capacitive touchscreen), a cursor control device 245 (e.g., a track pad, or capacitive touchscreen), a data storage device 255, and a transceiver 230.

Data storage device 255 includes a machine-readable medium 260 in which is stored one or more second sets of instructions 265 (e.g., software) embodying any one or more of the methodologies or functions described herein. Second set of instructions 265 may also reside, completely or at least partially, within main memory 215 and/or within processor 205 during execution thereof by communication device 120, static memory 225, and processor 205 also constituting machine-readable media. Second set of instructions 265 may further be transmitted or received over a network (not shown) via transceiver 230.

While first set of instructions 210 are shown in an exemplary embodiment to be on a single medium, the term “machine-readable medium” should be taken to include a single medium or multiple media (e.g., a centralized or distributed database or data source and/or associated caches and servers) that store the one or more second sets of instructions 265. The term “machine-readable medium” shall also be taken to include any medium that is capable of storing, encoding, or carrying a set of instructions for execution by communication device 120 and that cause communication device 120 to perform any one or more of the methodologies of the present invention. The term “machine-readable medium” shall accordingly be taken to include, but not be limited to, solid-state memories, and optical and magnetic media.

Communication device 120 may also include and/or be connected to token 125. Further details regarding token 125 are provided below with regard to FIG. 2. In some embodiments communication device 120 may include a port 265 via which communication device 120 may communicate with, for example, transaction device 110, server 130, proxy payment system 140, user account 150, and financial institution 170.

FIG. 3 is a block diagram illustrating an exemplary token 125. Token 125 may be resident in and/or communicatively attached to communication device 120. Information resident in token 125 may be populated by a user of, for example, communication device 120 during, for example, execution of a procedure to enroll in and/or manage an account with, for example, an identification verification system such as identification verification system 145 and/or a proxy payment service, such as proxy payment service 140 as provided by systems 100 and/or 101. Information resident in token 125 may have been populated by, for example, communication device 120, server 130, proxy payment system 140, user account 150, identification verification system 145, and/or financial institution 170. Token 125 may include globally unique identification (GUID) information 310, user identification information 320, and user account information 330.

GUID 310 may be information specific and/or unique to a communication device operated by a user, such as communication device 120. Exemplary GUIDs include a device ID, or serial number, that uniquely identifies the communication device, a type, or identifying characteristic, of the communication device, such as a brand name or functionality associated with the communication device, and an identity of an entity associated with the communication device such as a service provider (e.g., a mobile telecommunications company), manufacturer, or merchant.

User identification information 320 may be personal, biometric, or other information associated with a user operating communication device 120 and may be entered by user as part an account enrollment and/or maintenance procedure executed with one or more devices included in systems 100 and/or 101.

Exemplary user identification information 320 includes a user's name, a user's address, a user's phone number, a user's email address, a personal identification number (PIN), a user's fingerprint or other biometric information, and information specific to an account the user has with, for example, identity verification system 145 or server 140, such as a mother's maiden name or a pet's name.

User account information 330 may be information associated with the user and one or more components of, for example, systems 100 and/or 101. For example, user account information 330 may include information related to a user's account with financial institution 170, proxy payment system 140, and/or identification verification system 145. Exemplary user account information 330 includes an account number, a password, a geographic region associated with the account, and a type of service associated with the account.

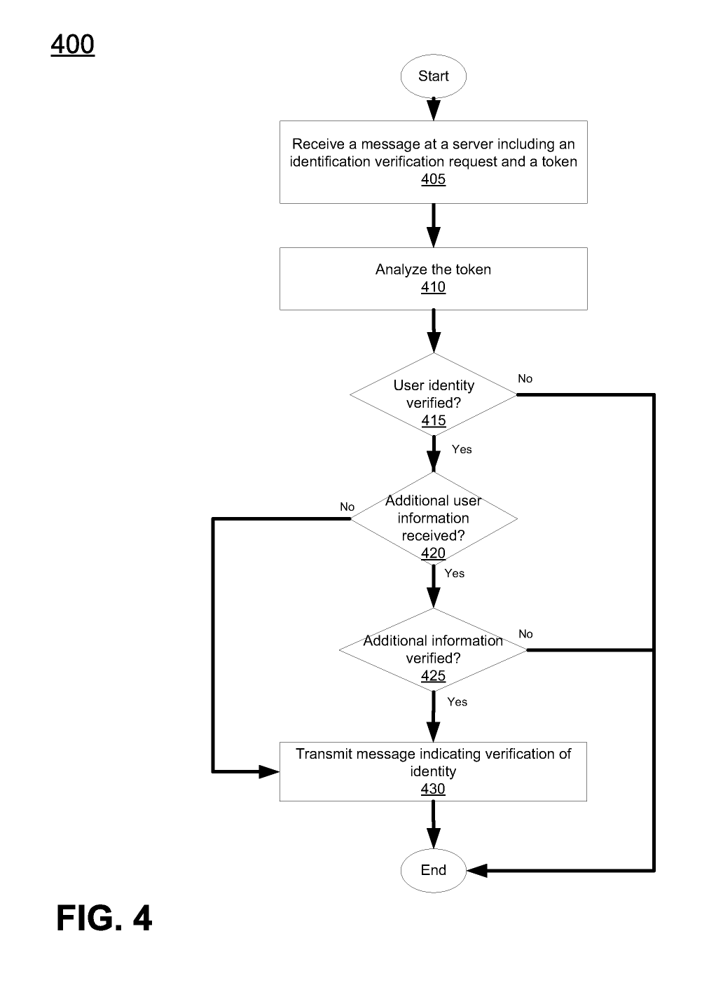

FIG. 4 is a flow chart showing an exemplary process 400 for verifying an identity. Process 400 may be executed by, for example, system 100, system 101, system 102, transaction device 110, communication device 120, token 125, server 130, identity verification system 145, and/or any combination thereof.

Prior to the execution of process 400, a user may enroll in an account with an identity verification system, such as identity verification system 145 and/or a server, such as server 130. The terms of enrollment may be dictated by, for example, the identity verification system, an entity for which a verified identity is provided, and/or the user. Enrollment into an account may include, for example, submission of user identification information according to, for example, a security protocol or legal requirement. Exemplary entities to which a verified identity may be provided include financial institutions, governmental entities, the Transportation Security Administration (TSA), members-only clubs, retail establishments, employers, and security personnel or equipment.

In step 405, a message including a request for an identity verification of a user may be received by, for example, a transaction device, such as transaction device 110 and/or a server, such as server 130. The request may be received from, for example, a communication device operated by the user, such as communication device 120. The request may be, for example, automatically initiated by, for example, entering into a geographic region in which a transaction device 110 automatically operates to capture messages, or initiated by the user. The message may also include a token, such as token 125. The token may include a GUID unique to the communication device and other user identification information associated with the user requesting the verification.

Exemplary GUIDs include a device ID, or serial number, that uniquely identifies the communication device, a type or identifying characteristic of the communication device, and an identity of an entity associated with the communication device such as a service provider e.g., a mobile telecommunications company. Exemplary user information includes a user's name, a user's address, a user's phone number, a user's account number, a user's email address, a personal identification number (PIN), and information specific to an account the user has with the identity verification system or server.

The message may be received via, for example, a wireless communication link and/or a physical connection between the communication device operated by a user and the transaction device. Exemplary physical connections between the communication device and the transaction device include touching the two devices together, connecting the two devices together via a wireless, or wired, communication link, and/or inserting the communication device into a port.

In some embodiments, the message may be received in response to a request for identification verification as may occur when proof of a user's identity is required. For example, verification of the user's identity may be required when the user is attempting to conduct a financial transaction, enter a secure location such as an airport or courthouse, prove membership to an organization such as a club or fitness establishment, or establish membership in a customer loyalty program offered by a retail establishment.

In step 410, the token may be analyzed by, for example, the server and/or the identification verification system according to one or more criteria, security protocols, and/or legal requirements. On some occasions, the analysis of step 410 may be conducted according to one or more requirements of an entity for which a verified identity is provided. Execution of step 410 may include, for example, determining the accuracy of the received token and looking up the received token against account information maintained by, for example, the user, server, and/or identity verification system. In some embodiments, step 410 may include requesting information necessary to verify a user's identity from, for example, the identity verification system and/or a user account with, for example, the server. Then, in step 415, the user's identity may be verified based on the analysis of step 410. When the users identity is not verified, process 400 may end.

Optionally, in step 420, it may be determined whether additional user information has been received by for example, the transaction device, and/or the server. In some embodiments, additional user information may be received in response to a prompt, or request, from, for example, the server and/or identification verification system. Exemplary additional user information includes a PIN and information specific to an account the user has with the identity verification system.

Then, in step 425, the accuracy of the received additional information may be verified. Step 425 may be executed by, for example, the server and/or identification verification system. In some cases, execution of step 425 may resemble execution of step 415. When the additional information is not verified, process 400 may end.

When no additional user information is received in step 420 and/or the additional information is verified in step 425, a message indicating that the user's identity has been verified may be transmitted to, for example, the transaction device and/or the communication device (step 430). Following step 430, process 400 may end.

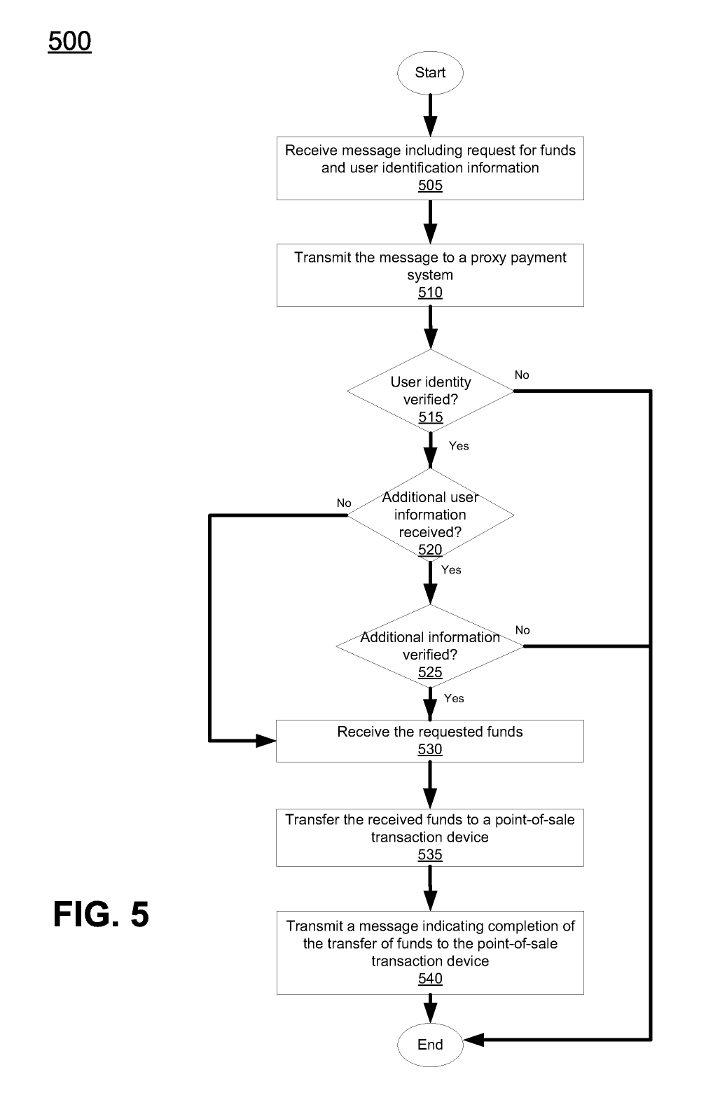

FIG. 5 is a flow chart showing an exemplary process 500 for completing a financial transaction. Process 500 may be executed by, for example, system 100, system 101, system 102, transaction device 110, communication device 120, token 125, server 130, proxy payment system 140, and/or any combination thereof.

Prior to the execution of process 500, a user may enroll in an account with a proxy payment system, such as proxy payment system 140 and/or server 130 and the terms of enrollment may be dictated by, for example, the proxy payment system, server, and/or the user. Enrollment into this account may include, for example, submission of user identification information and submission of information associated with a user's account with a financial institution, such as financial institution 170, to the proxy payment system according to, for example, a security protocol or legal requirement.

In step 505, a message including a request for funds and/or user identification information may be received by, for example, a transaction device, such as transaction device 110 and/or a server, such as server 130. The request may be received from, for example, a communication device operated by the user, such as communication device 120. The request may be, for example, automatically initiated or initiated by the user.

Exemplary user information includes a user's name, a user's address, a user's phone number, a user's account number, a user's email address, a PIN, information specific to an account the user has with the proxy payment system, information specific to an account the user has with a financial institution in communication with the proxy payment system, and a GUID specific to a communication device, such as communication device to 120, operated by the user requesting the funds via which the message is communicated to the transaction device.

Exemplary GUIDs include a device ID, or serial number, that uniquely identifies the communication device, a type or identifying characteristic of the communication device, an identity of an entity associated with the communication device such as a service provider e.g., a mobile telecommunications company. In some embodiments, a GUID may be associated with a token, such as token 125.

In some instances, the user identification information may include a token linked to a user's account with a financial institution, such as financial institution 170, and/or the proxy payment system, such as token 125. The token may include, for example, a GUID, user identification information, user account information, information specific to the proxy payment system, and/or information specific to a financial institution in communication with the proxy payment system. The proxy payment system may be enabled to access the account with the financial institution via the token.

The message may be received via, for example, a wireless communication link and/or a physical connection between a communication device operated by a user, such as communication device to 120, and the transaction device. Exemplary physical connections between the communication device and the transaction device include touching the two devices together, connecting the two devices together via a wireless or wired communication link, and/or inserting the communication device into a port.

In some embodiments, the message may be received in response to a merchant's request for funds in exchange for goods as may occur during a conventional financial, online, or retail sale transaction.

The received message may then be transmitted, or forwarded, to a proxy payment system, such as proxy payment system 140 (step 510). In step 515, the accuracy of the received user identification information may be verified according to, for example, one or more security criteria, security protocols, or security policies, privacy policies, or legal requirements. The verification of step 515 may be executed by, for example, the server, the proxy payment system, the financial institution, and/or some combination thereof.

On some occasions, the verification of step 515 may be conducted according to one or more requirements of the proxy payment system, transaction device, and/or financial institution. Execution of step 515 may include for example, determining the accuracy of received user identification information and looking up submitted user identification information against account information maintained by, for example, the user, server, proxy payment system, and/or financial institution and/or stored in database 135. In some embodiments, step 515 may include requesting information necessary to verify a user account from, for example, the proxy payment system, the financial institution, and/or a user account with, for example, the proxy payment system and/or financial institution. When the user identification information is not verified, process 500 may end.

Optionally, in step 520, it may be determined whether additional user information has been received by for example, the transaction device, and/or proxy payment system. In some embodiments, additional user information may be received in response to a prompt, or request, from, for example, the server and/or identification verification system. Exemplary additional user information includes a PIN, information specific to an account the user has with the proxy payment system, information specific to an account the user has with a financial institution in communication with the proxy payment system, and a GUID specific to a communication device operated by the user requesting the funds via which the message is communicated to the transaction device.

Then, in step 525, the accuracy of the received additional information may be verified. Step 525 may be executed by, for example, the server, proxy payment system, and/or financial institution. In some cases, execution of step 525 may resemble execution of step 515. When the additional information is not verified, process 500 may end.

When no additional user information is received in step 520 and/or the additional information is verified in step 525, the requested funds may be received by, for example, the server from, for example, the proxy payment system and/or financial institution (step 530). In one embodiment step 525 may include transferring the requested funds from the financial institution to the proxy payment system. The received funds may then be transferred to, for example, the transaction device (step 535).

In step 540, a message may be communicated to, for example, the transaction device indicating a transfer of funds from the proxy payment system to the transaction device. In one embodiment, a message may also be communicated to the user communication device indicating a transfer of funds from the financial institution and/or proxy payment system to the transaction device. Following step 540, process 500 may end.

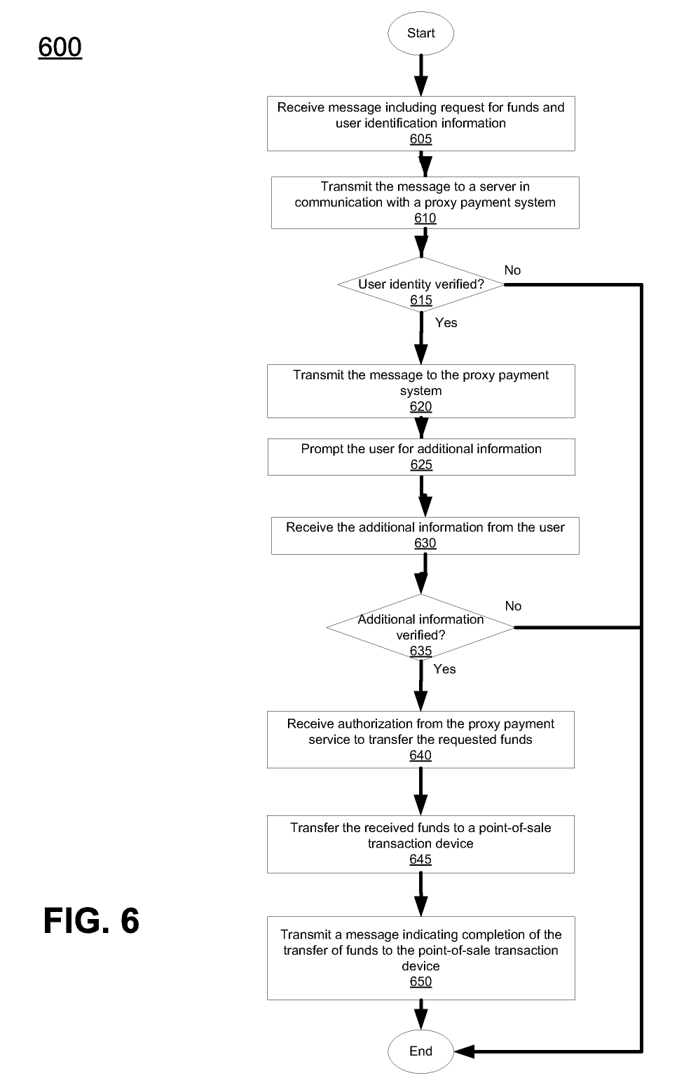

FIG. 6 is a flow chart showing an exemplary process 600 for completing a financial transaction. Process 600 may be executed by, for example, system 100, system 101, system 102, transaction device 110, communication device 120, token 125, server 130, proxy payment system 140, and/or any combination thereof.

Prior to the execution of process 600, a user may enroll in an account with a proxy payment system, such as proxy payment system 140 and/or server 130 and the terms of enrollment may be dictated by, for example, the proxy payment system, server, and/or the user. Enrollment into this account may include, for example, submission of user identification information and submission of information associated with a user's account with a financial institution, such as financial institution 170, to the proxy payment system according to, for example, a security protocol or legal requirement.

In step 605, a message including a request for funds and/or user identification information may be received by, for example, a transaction device, such as transaction device 110 and/or a server, such as server 130. The request may be received from, for example, a communication device operated by the user, such as communication device 120. The request may be, for example, automatically initiated or initiated by the user.

Exemplary user information includes a user's name, a user's address, a user's phone number, a user's account number, a user's email address, a PIN, information specific to an account the user has with the proxy payment system, information specific to an account the user has with a financial institution in communication with the proxy payment system, and a GUID specific to a communication device, such as communication device to 120, operated by the user requesting the funds via which the message is communicated to the transaction device.

Exemplary GUIDs include a device ID, or serial number, that uniquely identifies the communication device, a type or identifying characteristic of the communication device, and/or an identity of an entity associated with the communication device such as a service provider e.g., a mobile telecommunications company. In some embodiments, a GUID may be associated with a token, such as token 125.

In some instances, the user identification information may include a token linked to a user's account with a financial institution, such as financial institution 170, and/or the proxy payment system, such as token 125. The token may include, for example, a GUID, user identification information, user account information, information specific to the proxy payment system, and/or information specific to a financial institution in communication with the proxy payment system. The proxy payment system may be enabled to access the account with the financial institution via the token.

The message may be received via, for example, a wireless communication link and/or a physical connection between a communication device operated by a user, such as communication device 120, and the transaction device. Exemplary physical connections between the communication device and the transaction device include touching the two devices together, connecting the two devices together via a wireless, or wired communication link, and/or inserting the communication device into a port.

In some embodiments, the message may be received in response to a merchant's request for funds in exchange for goods as may occur during a conventional financial transaction, retail sale transaction, or online transaction.

The received message may then be transmitted, or forwarded, to a server, such as server 130, in communication with a proxy payment system, such as proxy payment system 140 (step 610). The proxy payment system may be in communication with a financial institution, such as financial institution 170.

In step 615, the accuracy of the received user identification information may be verified according to, for example, one or more security criteria, security protocols, or security policies, privacy policies, or legal requirements. The verification of step 615 may be executed by, for example, the server, the proxy payment system, the financial institution, and/or some combination thereof. Execution of step 615 may include for example, determining the accuracy of received user identification information and looking up submitted user identification information against account information maintained by the user, server, proxy payment system, and/or financial institution as may be stored in, for example, database 135. In some embodiments, step 615 may include requesting information necessary to verify a user account from, for example, a database, the proxy payment system, an identity verification system, such as identity verification system 145, the financial institution, and/or a user account with, for example, the proxy payment system and/or financial institution. When the user identification information is not verified, process 600 may end.

When the user identification information is verified, the message may be transmitted to the proxy payment system (step 620). In response, the proxy payment system may prompt the user for additional information via, for example, the transaction device and/or the communication device (step 625). The additional information may then be received from the user via, for example, the transaction device and/or the communication device (step 630).

Exemplary additional user information includes a PIN, information specific to an account the user has with the proxy payment system, information specific to an account the user has with a financial institution in communication with the proxy payment system, and a GUID specific to a communication device operated by the user requesting the funds via which the message is communicated to the transaction device. Step 635 may be executed by, for example, the server, proxy payment system, and/or financial institution. In step 635, the accuracy of received additional information may be verified. In some cases, execution of step 635 may resemble execution of step 615. When the additional information is not verified, process 600 may end.

When the additional information is verified in step 635, authorization to transfer the requested funds from for example the proxy payment system and/or a financial institution may be communicated to the server (step 640). The requested funds may then be transferred by, for example, the proxy payment system to the transaction device (step 645).

In step 650, a message may be communicated to, for example, the transaction device indicating a transfer of funds from the proxy payment system to the transaction device. In one embodiment, a message may also be communicated to the user communication device indicating a transfer of funds from the financial institution and/or proxy payment system to the transaction device. Following step 650, process 600 may end.

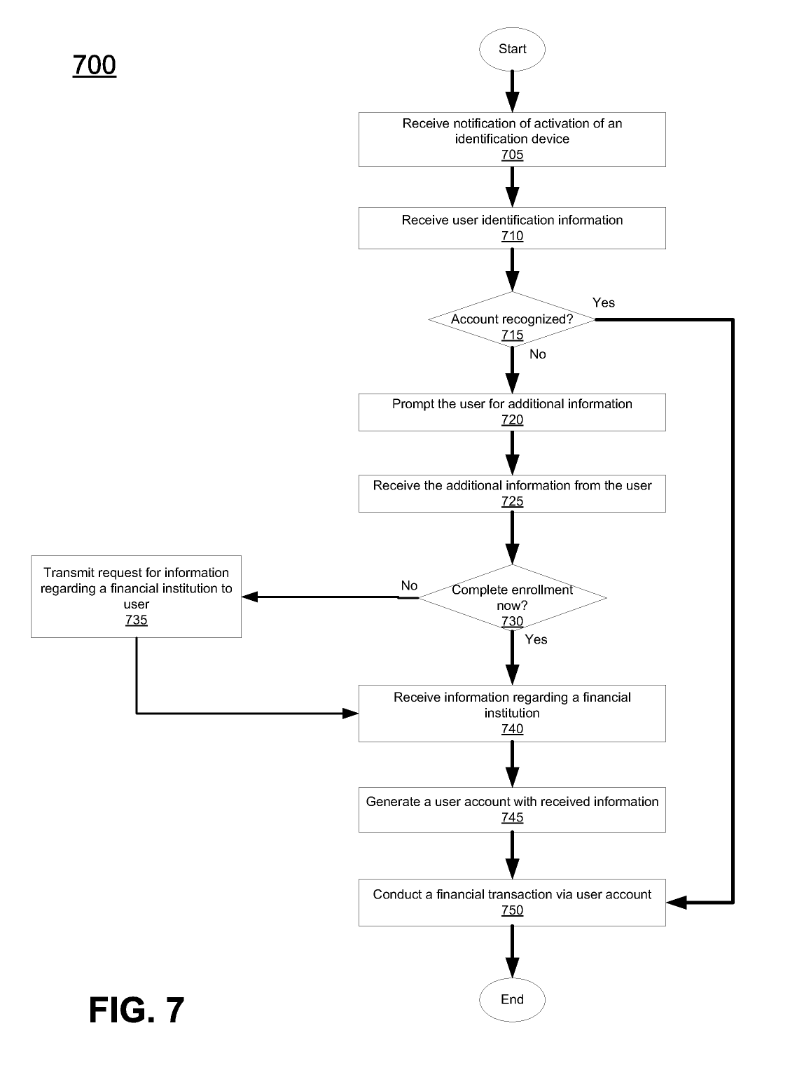

FIG. 7 is a flow chart showing an exemplary process 700 for conducting a financial transaction. Process 700 may be executed by, for example, system 100, system 101, system 102, transaction device 110, communication device 120, token 125, server 130, proxy payment system 140, and/or any combination thereof.

On some occasions, process 700 may be conducted at a retail point-of-sale and a user may elect to enroll in an account, such as user account 150, with a server, such as server 130, during execution of a transaction at, for example, the point-of-sale. Execution of process 700 may occur continuously or intermittently.

In step 705, notification of activation of an identification device may be received at, for example, the server. The identification device may be activated by the user in response to his or her election to enroll in an account with the server. In one embodiment, the identification device may be provided by an individual or entity operating a transaction device, such as transaction device 110. Exemplary identification devices include a token, such as token 125, a radio frequency identification (RFID) tag, a magnetic identification device, and a software application running on a communication device, such as a mobile phone.

In step 710, user identification information may be received at, for example, the server. The user identification information may be received via, for example, the transaction device and/or a communication device, such as communication device 120. Exemplary user identification information includes a user's name, a user's address, a user's phone number, a user's email address, a personal identification number (PIN), a user's fingerprint or other biometric information, a mother's maiden name, a pet's name, and information specific to an account the user has with, for example, a server or financial institution.

The notification of step 705 and the user identification information of step 710 may be received via, for example, a wired communication link, a wireless communication link, and/or a physical connection between, for example, the communication device and the transaction device.

In step 715, it may be determined whether a recognized account is associated with the identification device and/or the received user identification information. A recognized account may be a user account, such as user account 150. When an account is recognized, a financial transaction via the user account may be conducted (step 750). Exemplary financial transactions include a purchase of goods or services from a merchant, a like-kind exchange, a transfer of funds, and a refund.

When an account is not recognized, a user may be prompted for additional information via, for example, the transaction device and/or communication device (step 720). In step 725, the additional information may be received from the user. The additional information may include, for example, a user's name, a user's address, a user's phone number, a user's email address, a personal identification number (PIN), a user's fingerprint or other biometric information, and information regarding a personally identifying communication mechanism, such as an e-mail address, a street address, or a phone number, or an account number.

In step 730, it may be determined whether enrollment into an account with the server is to be completed while the user waits. This determination may be made via, for example, a selection by user of an option displayed on, for example, the transaction device and/or communication device. When enrollment is not to be completed now, a request for information regarding a financial institution may be transmitted to the user by, for example, the server (step 735). The request may be transmitted to, for example, the communication device via, for example, a personally identifying communication mechanism, such as an e-mail address or text message.

In step 740, information regarding a financial institution may be received by, for example, the user via any appropriate means, such as, the communication device or transaction device. Exemplary information regarding a financial institution includes an account number, a routing number, a credit card number, an expiration date, a PIN, a Social Security number, and employer ID number, and a student ID number.

Next, in step 745, a user account, such as user account 150, may be generated with some, or all, of the received information. A financial transaction may then be conducted via the user account. Exemplary financial transactions include a purchase of goods or services.

Thus, systems, apparatus, and methods for verifying a user's identity and conducting a transfer of funds via a payment proxy system have been herein provided.

What is claimed is:

1. A method comprising:
receiving, at a server, a first message from a transaction device, the first message includes i) a request, from a communication device operated by a user, for an identification verification of the user; and ii) a token including a globally unique identifier (GUID) unique to the communication device and user identification information associated with the user requesting the verification;
analyzing, by the server, the token;
verifying, by the server, an identification of the user in response to the analysis; and
transmitting, by the server, a second message to the transaction device indicating whether the identification is verified.

2. The method of claim 1, wherein the transaction device is associated with at least one of a merchant, an organization, a security verification entity, a members-only club, a retail establishment, and a government entity.

3. The method of claim 1, further comprising:
receiving, by the server, additional information from the user;
analyzing, by the server, the additional information; and
verifying, by the server, the accuracy of the received additional information in response to the analysis of the additional information.

4. The method of claim 3, wherein the additional information is at least one of a personal identification number (PIN) and information specific to an account the user has with an entity associated with the token.

5. The method of claim 1, wherein the communication device is a mobile communication device.

6. The method of claim 5, wherein the message is received by the server via at least one of a wireless communication link and a physical connection between the mobile communication device and the transaction device.

7. The method of claim 1, wherein the server is in communication with an identity verification database and the analysis of the token and the user identification information is based on communication between the server and the identity verification database.

8. A method comprising:
receiving, at a server, a message from a transaction device, the message includes i) a request for funds from a proxy payment system communicatively coupled to the server; and ii) user identification information associated with a user requesting the funds;
verifying, by the server, the accuracy of the user identification information;
transmitting, by the server, the message to the proxy payment system responsively to the verification;
receiving, by the server, the requested funds from the proxy payment system; and
transferring, by the server, the requested funds from the server to the transaction device.

9. The method of claim 8, further comprising:
receiving, by the server, additional information from the user; and
verifying, by at least one of the server and the proxy payment system, the accuracy of the received additional information, wherein at least one of the receipt of the requested funds and the transfer of requested funds is responsive to verification of the additional information.

10. The method of claim 9, wherein the additional information is at least one of a personal identification number (PIN), information specific to an account the user has with the proxy payment system, information specific to an account the user has with a financial institution in communication with the proxy payment system, and a globally unique identifier (GUID) specific to a communication device operated by the user requesting the funds via which the message is communicated to the transaction device.

11. The method of claim 8, wherein the message is received by the server via at least one of a wireless communication link and a physical connection between a communication device operated by the user and the transaction device.

12. The method of claim 8, further comprising:
transmitting, by the server, a message to at least one of the transaction device and a communication device indicating a transfer of funds from the proxy payment system to the transaction device.

13. The method of claim 8, wherein the user has an account with a financial institution and the proxy payment system, the user identification information includes a token linked to the account with the proxy payment system, the proxy payment system is enabled to access the account with the financial institution via the token.

14. The method of claim 8, wherein the proxy payment system is in communication with a financial institution and the requested funds are transferred to the proxy payment system from the financial institution prior to the transfer of the requested funds from the proxy payment system to the transaction device.

15. The method of claim 8, wherein the message is received by the transaction device from a communication device operated by the user and the user identification information includes a globally unique identifier (GUID) specific to the communication device and information specific to an account the user has with at least one of the payment proxy service and the financial institution.

16. A method comprising:
receiving, by a transaction device, a message from a communication device, the message includes i) a request for funds from a financial institution; and ii) user identification information associated with the communication device;
transmitting, by the transaction device, the message to a server in communication with a proxy payment system, wherein the proxy payment system is in communication with the financial institution;
verifying, by the server, the accuracy of the user identification information;
transmitting, by the server, the message to the proxy payment system responsively to the verification;
receiving authorization from the proxy payment system, by the server, to transfer requested funds from at least one of the proxy payment system and the financial institution, via a transfer by the proxy payment system, to the transaction device; and
transferring, by the server, the received funds to the transaction device.

17. The method of claim 16, further comprising:
prompting, by the transaction device, the user for additional information;
receiving, by the transaction device, the additional information from the user; and
verifying, by at least one of the transaction device, the server, and the proxy payment system, the accuracy of the received additional information, wherein at least one of the authorization and the transfer of the requested funds is responsive to verification of the additional information.

18. The method of claim 17, wherein the additional information is at least one of a personal identification number (PIN), information specific to an account the user has with the proxy payment system, and information specific to an account the user has with the financial institution.

19. The method of claim 16, wherein the message is received by the transaction device via at least one of a wireless communication link and a physical connection between the communication device and the transaction device.

20. The method of claim 16, further comprising:
transmitting, by the transaction device, a message to the communication device indicating a transfer of funds from at least one the proxy payment system and the financial institution to the transaction device.

21. The method of claim 16, wherein the user has an account with the financial institution and the proxy payment system, the user identification information includes a token linked to the account with the proxy payment system, and the proxy payment system is enabled to access the account with the financial institution via the token.

22. The method of claim 16, wherein the message is received by the transaction device from the communication device operated by the user and the user identification information includes a globally unique identifier (GUID) specific to the communication device and information specific to an account the user has with at least one of the payment proxy service and the financial institution.

23. A token comprising:
globally unique identification (GUID) information associated with a communication device operated by a user;
user identification information associated with the user; and
user account information associated with the user.

24. A system comprising:
a communication device comprising:
a user interface for receiving instructions from a user and a request for at least one of a user identification verification and funds from a proxy payment system;
a processor for processing the received instructions, the request, and a token; and
a transceiver for transmitting the request and the token and receiving at least one of a user identification verification and requested funds;
the token communicatively coupled to the communication device, the token comprising:
globally unique identification (GUID) information associated with the communication device;
user identification information associated with a user; and
user account information associated with the user and an entity maintaining the token; and
the transaction device communicatively coupled to the communication device and token and operable to read the token.

25. The system of claim 24, further comprising:
a server communicatively coupled to the transaction device and operable to communicate with at least one of an identification verification system and a proxy payment system.

26. A method comprising:
receiving, by a server, notification of an of activation of an identification device;
receiving, by the server, user identification information;
determining, by the server, whether a recognized account is associated with the identification device and received user identification information;
prompting, by the server, the user for additional information regarding an account the user has with a financial institution responsively to a determination that no recognized account is associated with the identification device and received user identification information;
receiving, by the server, the additional information from the user;
generating, by the server, a user account with the received information; and
conducting, by the server, a financial transaction via the user account.

27. The method of claim 26, wherein the identification device is a token.

28. The method of claim 26, wherein the received user identification information includes information regarding a personally identifying communication mechanism and the prompting includes transmitting, by the server, a request for information regarding an account the user has with a financial institution via the personally identifying communication mechanism.

29. The method of claim 26, wherein the notification and the user identification information are received via a secure encrypted transmission.
